(19) United States
(12) Patent Application Publication
(10) Pub. No.: US 2019/0032656 A1
(43) Pub. Date: Jan. 31, 2019

(54) ELECTRIC OIL PUMP

(71) Applicant: NIDEC TOSOK CORPORATION, Kanagawa (JP)

(72) Inventors: Yoshiyuki KOBAYASHI, Kanagawa (JP); Koji HIGUCHI, Kanagawa (JP); Yutaka HASHIMOTO, Kanagawa (JP); Shigehiro KATAOKA, Kanagawa (JP)

(73) Assignee: NIDEC TOSOK CORPORATION, Kanagawa (JP)

(21) Appl. No.: 16/048,376

(22) Filed: Jul. 30, 2018

(30) Foreign Application Priority Data
Jul. 31, 2017 (JP) 2017-148712
Jul. 6, 2018 (JP) 2018-128987

(51) Int. Cl. F04C 15/00; F04C 2/10; H02K 7/14; H02K 5/02; H02K 5/173; H02K 5/167

(52) U.S. Cl. CPC F04C 15/008; F04C 2/102; H02K 7/14; H02K 5/02; F04C 2240/52; H02K 5/167; F04C 2240/20; F04C 2240/40; F04C 2240/30; H02K 5/173

(57) ABSTRACT

An electric oil pump includes a motor unit having a shaft and a pump unit which is disposed on a front side of the motor unit, is driven by the shaft, and discharges oil. The motor unit includes a rotor, a stator, and a resin housing in which the rotor and the stator are housed. The pump unit includes a pump rotor provided at the shaft and a pump housing having a housing part in which the pump rotor is housed. The pump housing includes the pump body that is supported by the shaft via a sliding bearing and a pump cover that covers a front side of the pump body. A rear side of the shaft is supported by the resin housing via a rolling bearing and a front side of the shaft that protrudes from the motor unit is supported by a pump body via the sliding bearing.

### CROSS-REFERENCE TO RELATED APPLICATION

This application claims the priority of Japan patent applications serial no. 2017-148712, filed on Jul. 31, 2017 and no. 2018-128987, filed on Jul. 6, 2018. The entirety of the above-mentioned patent applications are hereby incorporated by reference herein and made a part of this specification.

### BACKGROUND

### Technical Field

The present disclosure relates to an electric oil pump.

### Description of Related Art

In recent years, when electric oil pumps used for transmissions mounted in vehicles have been installed in existing spaces in vehicles, there have been severe limitations in mounting, and reducing the size thereof is required so that they can be installed in various mounting spaces.

Regarding such electric oil pumps, an electric oil pump which includes a motor unit having a shaft and a pump unit that is disposed on one side of the motor unit in an axial direction and in which the pump unit is driven via the shaft of the motor unit and discharges oil is known. In this conventional electric oil pump, the shaft is supported by a pump body or a motor housing via a ball bearing and a sliding bearing, and thereby a reduction in size is realized.

For example, Japanese Laid-open Publication No. 2013-217223 discloses an electric oil pump in which a shaft that protrudes from one side of a motor unit in an axial direction is supported by a pump body via a ball bearing and a sliding bearing provided in the pump body of a pump unit. In addition, Japanese Laid-open publication No. 2017-053323 discloses an electric oil pump in which a shaft that protrudes from one side of a motor unit in an axial direction is supported by a motor housing via a ball bearing fixed to the motor housing, and a shaft that protrudes from the other side of a rotor on the side of the motor unit in the axial direction is supported by a motor housing via a sliding bearing.

In the electric oil pumps described in Japanese Laid-open Publication No. 2013-217223 and Japanese Unexamined Patent Application Publication No. 2017-053323, the shaft is supported by the sliding bearing in addition to the ball bearing. Since the sliding bearing supports the shaft that rotates while being in direct contact with the shaft, as the shaft rotates, an inner surface of the sliding bearing may wear.

When the inner surface of the sliding bearing wears, according to a positional relationship between the rotor on the side of the motor unit, and the ball bearing and the sliding bearing, the rotor on the side of the motor unit may be eccentric and the rotor may come in contact with a stator.

### SUMMARY

An exemplary first embodiment of the present disclosure is an electric oil pump including a motor unit having a shaft centered on a central axis that extends in an axial direction of the shaft; and a pump unit which is disposed on one side of the motor unit in the axial direction, is driven by the motor unit via the shaft, and discharges oil, wherein the motor unit includes a rotor that is fixed to an other side of the shaft in the axial direction; a stator that is disposed outside the rotor in a radial direction; and a resin housing in which the rotor and the stator are housed, wherein the pump unit includes a pump rotor installed to the shaft that protrudes from the motor unit to the one side in the axial direction; and a pump housing having a housing part in which the pump rotor is housed, wherein the pump housing includes a pump body that is supported by the shaft via a sliding bearing; and a pump cover that covers one side of the pump body in the axial direction, wherein the other side of the shaft in the axial direction is supported by the resin housing via a rolling bearing, and wherein one side of the shaft that protrudes from the motor unit in the axial direction is supported by the pump body via the sliding bearing.

The above and other elements, features, steps, characteristics and advantages of the present disclosure will become more apparent from the following detailed description of the exemplary embodiments with reference to the attached drawings.

### BRIEF DESCRIPTION OF THE DRAWINGS

FIG. 1 is a cross-sectional view of an electric oil pump according to a first embodiment.

FIG. 2 is an enlarged cross-sectional view of a rolling bearing holding part according to the first embodiment.

FIG. 3 is an enlarged partial cross-sectional view of a front side of a resin housing according to the first embodiment.

FIG. 4 is an enlarged cross-sectional view of a motor side flange part of the resin housing according to the first embodiment.

FIGS. 5a-5c are a cross-sectional views of a rolling bearing holding part according to modified examples of the first embodiment.

FIG. 6 is a cross-sectional view of a pump body holding part of a resin housing according to the modified example of the first embodiment.

FIG. 7 is a cross-sectional view of the pump body holding part according to the modified example of the first embodiment.

### DESCRIPTION OF THE EMBODIMENTS

The present disclosure provides an electric oil pump through which, when a support of a shaft is supported via a ball bearing and a sliding bearing, it is possible to prevent a possibility of a rotor on the side of a motor becoming eccentric and coming in contact with a stator even if the sliding bearing wears.

According to the exemplary first embodiment of the present disclosure, it is possible to provide an electric oil pump through which, when a support of a shaft is supported via a ball bearing and a sliding bearing, it is possible to prevent a possibility of a motor rotor becoming eccentric and coming in contact with a stator even if the sliding bearing wears.

An electric oil pump according to an embodiment of the present disclosure will be described below with reference to the drawings. In addition, in the following drawings, in order to allow respective configurations to be easily understood, actual structures and scales and numbers in the structures may vary.

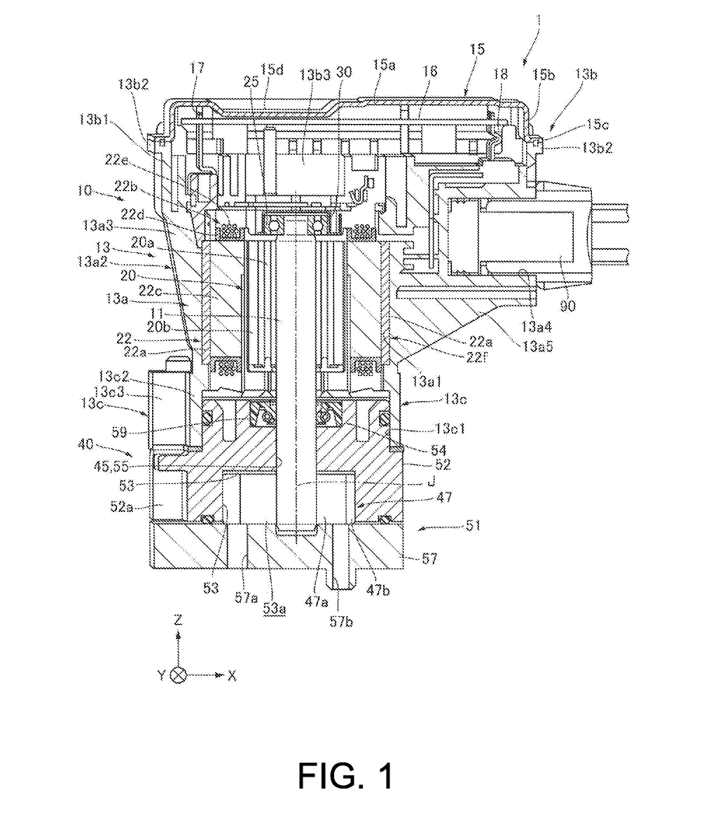

In addition, in the drawings, an XYZ coordinate system is appropriately shown as a three-dimensional orthogonal coordinate system. In the XYZ coordinate system, a Z axial direction is a direction parallel to the other side of a central axis J shown in FIG. 1 in the axial direction. An X axial direction is a direction parallel to an electric oil pump shown in FIG. 1 in a transverse direction, that is, a left-right direction in FIG. 1. A Y axial direction is a direction orthogonal to both the X axial direction and the Z axial direction.

In addition, in the following description, the positive side (+Z side) in the Z axial direction will be referred to as “rear side” and the negative side (−Z side) in the Z axial direction will be referred to as “front side.” Here, the rear side and the front side are terms that are simply used for explanation, and do not limit actual positional relationships and directions. In addition, unless otherwise noted, a direction (the Z axial direction) parallel to the central axis J is simply defined as an “axial direction,” a radial direction around the central axis J is simply defined as a “radial direction,” and a circumferential direction around the central axis J, that is, a circumference (θ direction) around the central axis J is simply defined as a “circumferential direction.”

Here, in this specification, the term “extending in the axial direction” includes not only extending strictly in the axial direction (the Z axial direction) but also extending in a direction inclined in a range of less than 45° with respect to the axial direction. In addition, in this specification, the term “extending in the radial direction” includes not only extending strictly in the radial direction, that is, extending in a direction perpendicular to the axial direction (the Z axial direction), but also extending in a direction inclined in a range of less than 45° with respect to the radial direction.

<Overall Structure>

FIG. 1 is a cross-sectional view of an electric oil pump according to a first embodiment. As shown in FIG. 1, an electric oil pump 1 of the present embodiment includes a motor unit 10 and a pump unit 40. The motor unit 10 and the pump unit 40 are aligned in the axial direction.

The motor unit 10 has a shaft 11 that is disposed along the central axis J that extends in the axial direction. The pump unit 40 is disposed on one side (front side) of the motor unit 10 in the axial direction and is driven by the motor unit 10 via the shaft 11 and discharges oil. Constituent members will be described below in detail.

<Motor Unit 10>

As shown in FIG. 1, the motor unit 10 includes a resin housing 13, a rotor 20, the shaft 11, a stator 22, and a rolling bearing 25.

The motor unit 10 is, for example, an inner rotor type motor. The rotor 20 is fixed to an outer circumferential surface of the shaft 11. The stator 22 is disposed outside the rotor 20 in the radial direction. In addition, the rolling bearing 25 is disposed at a rear side (+Z side) end of the shaft 11 and rotatably supports the shaft 11.

(Resin Housing 13)

As shown in FIG. 1, the resin housing 13 includes a stator holding part 13a, a circuit board holding part 13b, and a pump body holding part 13c. The stator holding part 13a, the circuit board holding part 13b, and the pump body holding part 13c are integrally molded using a resin.

(Stator Holding Part 13a)

The stator holding part 13a extends in the axial direction and has a through-hole 13a1 therein. The shaft 11 of the motor unit 10, the rotor 20, and the stator 22 are disposed in the through-hole 13a1. An outer surface of the stator 22, that is, an outer surface of a core back part 22a to be described below, is fitted to an inner surface of the stator holding part 13a. Thereby, the stator 22 is housed in the stator holding part 13a.

The left side of an outer wall 13a2 of the stator holding part 13a of the present embodiment in the X axial direction has a left side wall 13a3 whose thickness in the radial direction of the resin increases from the front side (−Z side) to the rear side (+Z side). In addition, the right side of the outer wall 13a2 in the X axial direction include an insertion hole 13a4 which extends in the X axial direction and into which an external connector 90 is inserted. A bracket part 13a5 that supports the insertion hole 13a4 is provided on the front side of the insertion hole 13a4. The rigidity of the insertion hole 13a4 is strengthened by the bracket part 13a5.

(Circuit Board Holding Part 13b)

The circuit board holding part 13b is continuously connected to the rear side end of the stator holding part 13a. The circuit board holding part 13b has a bottomed container shape of which the rear side opens and which extends in the X axial direction and includes a container body part 13b1 and a container body side flange part 13b2.

The container body part 13b1 has a substrate housing chamber 13b3. The rear side of the substrate housing chamber 13b3 opens, and a rear side opening of the substrate housing chamber 13b3 is covered by a cover part 15. A circuit board 16, a motor side terminal 17, a connector side terminal 18, and the like are housed in the substrate housing chamber 13b3.

The motor side terminal 17 is disposed on the left side in the X axial direction in the substrate housing chamber 13b3, one end side is electrically connected to a coil 22b of the motor unit 10, and the other end side is electrically connected to the circuit board 16. The connector side terminal 18 is disposed on the right side in the X axial direction in the substrate housing chamber 13b3, one end side is electrically connected to the external connector 90, and the other end side is electrically connected to the circuit board 16.

The circuit board 16 outputs a motor output signal. In the present embodiment, the circuit board 16 is disposed on the rear side of the substrate housing chamber 13b3 and extends in the X axial direction. A print wiring (not shown) is provided on the back surface (front side surface) of the circuit board 16. In addition, when a copper inlay substrate is used as the circuit board 16, heat generated in a heating element (not shown) can be dissipated through the cover part.

The cover part 15 is made of a metal material, and since it has a large thermal capacity and has a surface area, a heat dissipation effect is strong. In the present embodiment, the cover part 15 includes a top part 15a that extends along the circuit board 16, a side wall 15b that extends from the outer edge of the top part 15a to the front side, and a cover side flange part 15c that protrudes outward from the front side end of the side wall 15b.

The cover side flange part 15c is disposed to face the container body side flange part 13b2 provided in the container body part 13b1, and is fixed to the container body side flange part 13b2 by a fastening unit such as a bolt. The top part 15a has a recess 15d that is recessed toward the circuit board 16 on the left side in the X axial direction. A tip of the recess 15d is in contact with the circuit board 16 with a heat transfer member (not shown) therebetween. Thus, heat generated from the circuit board 16 can be effectively dissipated through the heat transfer member and the cover part 15.

(Pump Body Holding Part 13c)

The pump body holding part 13c has a tubular shape of which the front side opens, and is continuously connected to the front side end of the stator holding part 13a. The pump body holding part 13c has a hole 13c1 that extends in the axial direction. The inner diameter of the hole 13c1 has a size that is slightly larger than the outer diameter on the rear side of a pump body 52 of the pump unit 40 to be described below. The rear side of the pump body 52 is fitted to the inner surface of the hole 13c1.

An outer surface 13c2 of the pump body holding part 13c includes a motor side flange part 13c3 that protrudes in the radial direction. The motor side flange part 13c3 is disposed to face a pump side flange part 52a provided in the pump body 52 to be described below, and is fixed to the pump side flange part 52a by a fastening unit such as a bolt. Thereby, the pump unit 40 is fixed to the resin housing 13.

(Rotor 20)

The rotor 20 includes a rotor core 20a and a rotor magnet 20b. The rotor core 20a surrounds the shaft 11 around the axis (θ direction) and is fixed to the shaft 11. The rotor magnet 20b is fixed to the outer surface along the axis (θ direction) of the rotor core 20a. The rotor core 20a and the rotor magnet 20b rotate together with the shaft 11. Here, the rotor 20 may be an embedded magnet type in which a permanent magnet is embedded in the rotor 20. Compared to a surface magnet type in which a permanent magnet is provided on a surface of the rotor 20, the rotor 20 of the embedded magnet type can reduce a likelihood of the magnet peeling off due to a centrifugal force, and can utilize a reluctance torque positively.

(Stator 22)

The stator 22 surrounds the rotor 20 around the axis (θ direction), and rotates the rotor 20 around the central axis J. The stator 22 includes the core back part 22a, a tooth part 22c, the coil 22b, and an insulator (bobbin) 22d.

The shape of the core back part 22a is a cylindrical shape concentric with the shaft 11. The tooth part 22c extends from the inner surface of the core back part 22a toward the shaft 11. A plurality of tooth parts 22c are provided and are disposed at uniform intervals in the circumferential direction on the inner surface of the core back part 22a. The coil 22b is provided around the insulator (bobbin) 22d and is formed by winding a conductive wire 22e. An insulator (bobbin) 19 is installed to each of the tooth parts 22c. The stator 22 includes a resin molded part 22f in which the core back part 22a, the tooth part 22c, the coil 22b, and the insulator (bobbin) 22d are covered with a resin when integral molding using a resin is performed.

(Rolling Bearing 25)

The rolling bearing 25 is disposed on the rear side (+Z side) of the rotor 20 and the stator 22 and is held by a rolling bearing holding part 30. The rolling bearing 25 supports the shaft 11. The shape, the structure, and the like of the rolling bearing 25 are not particularly limited, and any known bearing can be used.

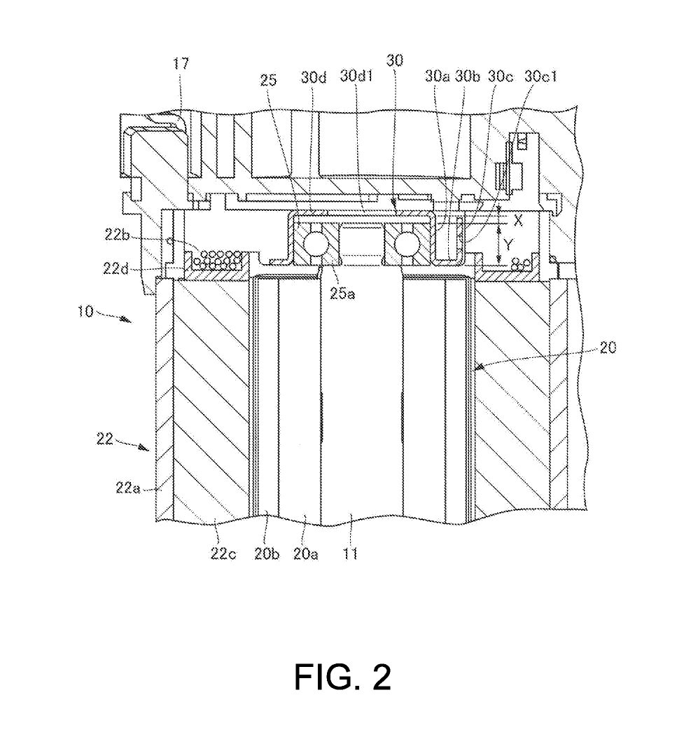

FIG. 2 is an enlarged cross-sectional view of the rolling bearing holding part 30 according to the present embodiment. As shown in FIG. 2, the rolling bearing holding part 30 holds the rolling bearing 25. In the present embodiment, the rolling bearing holding part 30 includes a ring part 30a, a rim part 30b, a protrusion part 30c, and a top part 30d. The ring part 30a has an annular ring shape, and surrounds and holds the outer circumference of the rolling bearing 25. The ring part 30a is formed of a metal member. The ring part 30a has a height that is slightly larger than a thickness Y of the rolling bearing 25 in the axial direction. Therefore, the entire rolling bearing 25 can be housed and held in the ring part 30a. In addition, a gap with a size X that does not exceed a width Y of the bearing 25 in the axial direction is provided between the rear side end of the shaft 11 and the inner surface of the top part 30d of the rolling bearing holding part 30.

The rim part 30b protrudes from the front side (−Z side) end of the ring part 30a to the outer side in the radial direction and has an annular ring shape in the circumferential direction. Here, the plurality of rim parts 30b may be provided at intervals in the circumferential direction. The protrusion part 30c extends from the outer end of the rim part 30b in the radial direction to the rear side (+Z side). The protrusion part 30c may be provided on a part of the rim part 30b that extends in a ring shape in the circumferential direction, and when the plurality of rim parts 30b are provided at intervals in the circumferential direction, the protrusion part 30c may be provided on all or some of the plurality of rim parts 30b. The protrusion part 30c has a through-hole 30c1 that penetrates through the protrusion part 30c. Here, when the protrusion part 30c is provided in a ring shape, the plurality of through-holes 30c1 are provided at the protrusion part 30c. In addition, when the plurality of protrusion parts 30c are provided, the through-hole 30c1 may be provided at all or some of the plurality of protrusion parts 30c.

The top part 30d covers an opening on the rear side (+Z side) of the ring part 30a. In the present embodiment, the top part 30d has a circular shape, and a hole 30d1 is provided at the central part of the top part 30d. The inner diameter of the hole 30d1 is smaller than the outer diameter of an inner ring 25a of the rolling bearing 25 and is larger than the inner diameter of the inner ring 25a. Therefore, when the rolling bearing 25 moves to the rear side (+Z side) within the rolling bearing holding part 30, since the entire rolling bearing 25 comes in contact with the inner surface of the top part 30d, it is possible to effectively prevent movement of the rolling bearing 25. In addition, when the hole 30d1 is provided, it is possible to reduce the weight of the rolling bearing holding part 30. The rolling bearing holding part 30 is integrated with the resin housing 13 together with the resin housing 13 by insert molding.

(Shaft 11)

As shown in FIG. 1, the shaft 11 extends along the central axis J and penetrates through the motor unit 10. The front side (−Z side) of the shaft 11 protrudes from the motor unit 10 and extends into the pump unit 40. The front side (−Z side) of the shaft 11 is supported by a sliding bearing 45 in the pump body 52 to be described below.

<Pump Unit 40>

The pump unit 40 is disposed on one side of the motor unit 10 in the axial direction, and specifically, on the front side (−Z side). The pump unit 40 is driven by the motor unit 10 via the shaft 11. The pump unit 40 includes a pump rotor 47 and the pump housing 51. The pump housing 51 includes the pump body 52 and a pump cover 57. These components will be described below in detail.

(Pump Body 52)

The pump body 52 is fixed to the front side (−Z side) of the resin housing 13 on the front side (−Z side) of the motor unit 10. The pump body 52 includes a housing part 53 in which the pump rotor 47 is housed and has a side surface and a bottom that is disposed on the rear side (+Z side) of the motor unit 10. The housing part 53 opens to the front side (−Z side) and is recessed to the rear side (+Z side). The shape of the housing part 53 when viewed in the axial direction is a circular shape.

The pump body 52 has a recess 54 that is recessed from a rear side (+Z side) surface to the front side (−Z side). A sealing member 59 is housed in the recess 54. The shape of the recess 54 when viewed in the axial direction is a circular shape.

The pump body 52 has a through-hole 55 that penetrates along the central axis J. Both ends of the through-hole 55 open in the axial direction and the shaft 11 passes therethrough, and an opening on the rear side (+Z side) opens to the recess 54. An opening on the front side (−Z side) opens to the housing part 53. The through-hole 55 functions as the sliding bearing 45 that rotatably supports the shaft 11.

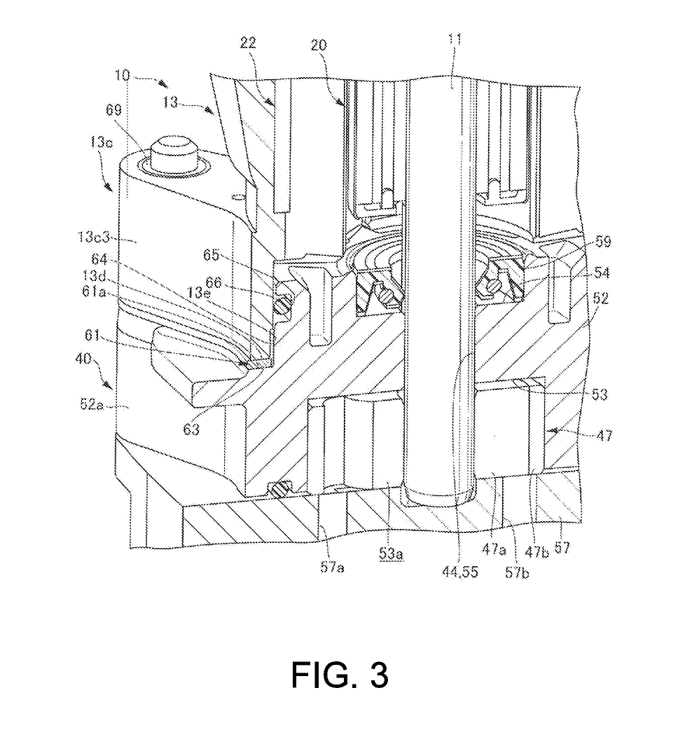

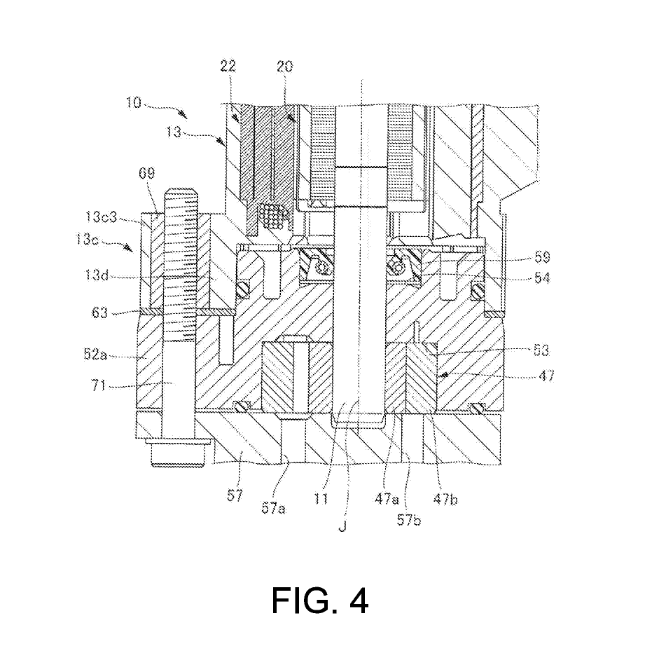

FIG. 3 is an enlarged partial cross-sectional view of the rear side of the resin housing 13 according to the present embodiment. FIG. 4 is an enlarged cross-sectional view of the motor side flange part 13c3 of the resin housing 13 according to the present embodiment. As shown in FIG. 3, the pump body 52 has a step 61 that is recessed inwardly in the radial direction on the outer surface outside the rear side (+Z side) in the radial direction. The step 61 has an end wall surface 61a having a ring shape. When a front side end 13d of the resin housing 13 is brought into contact with the end wall surface 61a, it is possible to position the resin housing 13 with respect to the pump body 52 in the axial direction. In the present embodiment, the front side end 13d of the resin housing 13 is in contact with the end wall surface 61a via a metal plate 63 disposed on the end wall surface 61a. The step 61 is disposed between the sealing member 59 provided in the recess 54 and the housing part 53.

In the present embodiment, the metal plate 63 is provided between the resin housing 13 and the pump body 52. In the resin housing 13, knurls are provided on the outer surface, and the collar 69 in which a female thread is provided on the inner circumferential surface is inserted thereinto, and specifically, is inserted on the step 61. The metal plate 63 has a size substantially the same as the size of the front side end 13d of the resin housing 13 in the radial direction. The reason why the metal plate 63 is disposed between the resin housing 13 and the pump body 52 is as follows. The size of the external form of the resin housing 13 cannot be increased because of a relationship with an installation space of the electric oil pump 1. Therefore, the wall thickness of the collar 69 of the resin housing 13 that is in contact with the pump body 52 of the resin housing 13 cannot be sufficiently secured. Therefore, when the resin housing 13 and the pump body 52 are fastened, there is a possibility of the pump body 52 buckling. Therefore, when the metal plate 63 made of iron is placed between the resin housing 13 and the pump body 52, even if the wall thickness of the collar 69 is not sufficiently formed, buckling can be prevented even when the pump body 52 is made of aluminum.

A circumferential wall surface 64 continuously extends to the rear side (+Z side) at the inner end of the end wall surface 61a in the radial direction. An annular recess 65 that is recessed to the inner side in the radial direction is provided on the rear side (+Z side) of the circumferential wall surface 64. In the recess 65, a sealing member 66 is provided. In the shown embodiment, an O-ring is provided in the recess 65.

The circumferential wall surface 64 on the front side (−Z side) with respect to the recess 65 is fitted to an inner wall surface 13e on the front side (−Z side) of the resin housing 13. Therefore, the resin housing 13 can be positioned with respect to the pump body 52 in the radial direction.

The pump side flange part 52a is provided on the outer side of the end wall surface 61a of the step 61 in the radial direction. The pump side flange part 52a continuously extends in continuation with the end wall surface 61a. In the present embodiment, the four pump side flange parts 52a are provided at intervals in the circumferential direction.

The pump side flange part 52a is disposed to face the motor side flange part 13c3 when the front side end 13d of the resin housing 13 is in contact with the step 61, and when the pump side flange part 52a and the motor side flange part 13c3 are fastened by a fastening unit such as a bolt, the motor unit 10 can be fixed to the pump unit 40.

(Pump Rotor 47)

The pump rotor 47 is installed to the shaft 11. More specifically, the pump rotor 47 is installed to the front side (−Z side) of the shaft 11. The pump rotor 47 includes an inner rotor 47a installed to the shaft 11 and an outer rotor 47b that surrounds the outer side of the inner rotor 47a in the radial direction. The inner rotor 47a has an annular ring shape. The inner rotor 47a is a gear having teeth on the outer surface in the radial direction.

The inner rotor 47a is fixed to the shaft 11. More specifically, the front side (−Z side) end of the shaft 11 is press-fitted into the inner rotor 47a. The inner rotor 47a rotates around the axis (θ direction) together with the shaft 11. The outer rotor 47b has an annular ring shape that surrounds the outer side of the inner rotor 47a in the radial direction. The outer rotor 47b is a gear having teeth on the inner surface in the radial direction.

The inner rotor 47a is engaged with the outer rotor 47b and when the inner rotor 47a rotates, the outer rotor 47b rotates. That is, the pump rotor 47 rotates according to rotation of the shaft 11. In other words, the motor unit 10 and the pump unit 40 have the same rotation axis. Thereby, it is possible to prevent the size of the electric oil pump 1 from becoming larger in the axial direction.

In addition, when the inner rotor 47a and the outer rotor 47b rotate, a volume between engaging parts of the inner rotor 47a and the outer rotor 47b changes. An area in which the volume decreases is a pressing area, and an area in which the volume increases is a negative pressure area. An intake port is disposed on the front side (−Z side) of the negative pressure area of the pump rotor 47. In addition, a discharge port is disposed on the front side (−Z side) of a pressing area Ap of the pump rotor 47. Here, oil sucked into the housing part 53 from an intake opening 57a provided in the pump cover 57 is stored in a volume part between the inner rotor 47a and the outer rotor 47b and is sent to the pressing area. Then, the oil passes through the discharge port and is discharged from a discharge opening 57b provided in the pump cover 57.

(Pump Cover 57)

As shown in FIG. 1, the pump cover 57 is covered from the front side (−Z side) with respect to the pump body 52, and thus the housing part 53 is provided between the pump cover 57 and the pump body 52. In the present embodiment, the pump cover 57 is installed to the front side (−Z side) of the pump body 52 and blocks an opening 53a that opens to the front side (−Z side) of the housing part 53, and thus the housing part 53 is provided between the pump cover 57 and the pump body 52.

<Operations and Effects of Electric Oil Pump 1>

Next, operations and effects of the electric oil pump 1 will be described. As shown in FIG. 1, when the motor unit 10 of the electric oil pump 1 is driven, the shaft 11 of the motor unit 10 rotates, and as the inner rotor 47a of the pump rotor 47 rotates, the outer rotor 47b also rotates. When the pump rotor 47 rotates, oil sucked from the intake opening 57a of the pump unit 40 moves through the housing part 53 of the pump unit 40, passes through the discharge port, and is discharged from the discharge opening 57b.

(1) Here, in the electric oil pump 1 according to the present embodiment, when the sliding bearing 45 wears during rotation of the shaft 11 and the shaft 11 that protrudes from the motor unit 10 to the front side (−Z side) is eccentric with respect to the central axis, since the rear side (+Z side) of the shaft 11 is supported by the rolling bearing 25, the eccentricity on the rear side (+Z side) of the shaft 11 is reduced. Therefore, the eccentricity of the rotor 20 disposed on the rear side (+Z side) of the shaft 11 is reduced and it is possible to prevent a possibility of the rotor 20 coming in contact with the stator 22. In addition, since the resin housing 13 of the motor unit 10 is made of a resin, compared to when the housing of the motor unit 10 is made of a metal, it is possible to reduce the weight of the electric oil pump 1 and reduce the cost thereof

(2) Since the stator 22 has the resin molded part 22f, the resin molded part 22f is filled into constituent components (for example, the coil 22b, the tooth part 22c, and the core back part 22a) of the stator 22, and it is possible to improve the rigidity of the constituent components of the stator 22.

(3) Since the rolling bearing 25 is held via the rolling bearing holding part 30, even if the rolling bearing 25 is shifted from the resin housing 13, the rolling bearing 25 does not come into contact with the resin housing 13. Therefore, it is possible to prevent the resin housing 13 from wearing. In addition, since the rolling bearing holding part 30 is formed of a metal member, the holding rigidity of the rolling bearing 25 is higher and it is possible to further reduce a possibility of the rolling bearing 25 being shifted and coming in contact with the resin housing 13. Therefore, it is possible to further reduce wear of the resin housing 13.

(4) Since the rolling bearing holding part 30 has the ring part 30a, the outer circumferential surface of the rolling bearing 25 can be brought into contact with the inner surface of the ring part 30a in the circumferential direction. Therefore, bearing holding of the rolling bearing 25 can be performed more reliably.

(5) Since the rolling bearing holding part 30 has the rim part 30b, when the rim part 30b is positioned with respect to a mold during insert molding, it is possible to easily perform positioning of the rolling bearing holding part 30 in the axial direction with respect to the resin housing 13. In addition, since the rolling bearing holding part 30 has the top part 30d, displacement of the shaft 11 to the rear side is restricted, and it is possible to prevent a possibility of the rear side end of the shaft 11 coming in contact with the resin housing 13 and the resin housing 13 wearing.

(6) Since the rolling bearing holding part 30 is integrated with the resin housing 13 by insert molding, it is possible to mass-produce an integrally molded article in which the rolling bearing holding part 30 is disposed in a resin housing with high accuracy.

(7) Since the rim part 30b includes the protrusion part 30c that protrudes to the side (+Z side) behind the ring part 30a, when the rolling bearing holding part 30 tries to rotate around the central axis according to rotation of the shaft 11 during the driven of the motor unit 10, if the protrusion part 30c is provided over the entire circumference of the rolling bearing holding part 30 in the circumferential direction, rotation of the rolling bearing holding part 30 can be prevented by a bonding force between the protrusion part 30c and the resin filled in during insert molding. In addition, when the protrusion part 30c is provided in a part of the rolling bearing holding part 30 in the circumferential direction, the protrusion part 30c hits the resin filled during insert molding and rotation of the rolling bearing holding part 30 can be prevented. That is, when the rim part 30b includes the protrusion part 30c that protrudes to the other side of the ring part 30a in the axial direction, rotation of the rolling bearing holding part 30 can be prevented.

(8) When the step 61 is provided on the outer surface outside the pump body 52 in the radial direction, if the front side end of the resin housing 13 is brought into contact with the step 61, it is possible to position the resin housing 13 with respect to the pump body 52. In addition, when the front side end (one side end in the axial direction) of the resin housing 13 is fixed to the step 61, the resin housing 13 can be fixed while it is positioned with respect to the pump body 52.

(9) Since the pump body 52 has the recess 54 that is recessed to the front side (one side in the axial direction) from a surface on the rear side (the other side in the axial direction), the sliding bearing 45 is the through-hole 55 that allows communication between the recess 54 and the housing part 53, and the sealing member 59 is provided in the recess 54, a part of oil that flows into the housing part 53 when the pump unit 40 is driven flows toward the motor unit 10 via the sliding bearing 45. However, since the sealing member 59 is disposed in the recess 54 provided on the side of the motor unit 10 of the through-hole 55, it is possible to reduce a possibility of oil flowing in the sliding bearing 45 being discharged toward the motor unit 10.

In addition, since the sliding bearing 45 is the through-hole 55 that allows communication between the recess 54 and the housing part 53, the sliding bearing 45 allows communication with the housing part 53. Therefore, a part of oil flowing into the housing part 53 when the pump unit 40 is driven can flow toward the sliding bearing 45. Therefore, it is possible to reduce wear of the sliding bearing 45.

(10) Since the rear side end of the resin housing 13 is disposed between the sealing member 59 and the housing part 53, there is no resin housing 13 outside the housing part 53 in the radial direction and no step 61 is provided. Here, in order to increase an amount of discharge by the pump unit 40 without increasing the size of the electric oil pump 1, there is a need to increase the size of the pump rotor 47 and change the size of the diameter of the housing part 53 in which the pump rotor 47 is housed. In this case, since the resin housing 13 and the step 61 are not present outside the housing part 53 in the radial direction, it is possible to increase the degree of freedom in designing for providing the housing part 53 for enlarging the outer diameter in the pump body 52.

### Modified Examples of First Embodiment

### (Modified Example in Which Structure of Rolling Bearing Holding Part is Simplified)

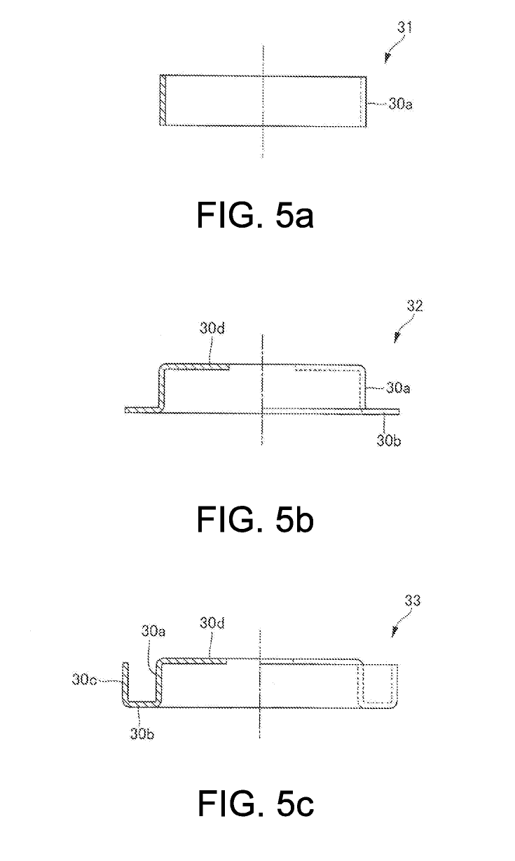

The rolling bearing holding part 30 according to the first embodiment shown in FIG. 1 includes the ring part 30a, the rim part 30b, the protrusion part 30c, the top part 30d, and the through-hole 30c1. However, the present disclosure is not limited to this structure. For example, as shown in FIG. 5a, a rolling bearing holding part 31 can be composed of only the ring part 30a without the rim part 30b, the protrusion part 30c, the top part 30d, and the through-hole 30c1 (Modified Example 1).

Since the structure of the ring part 30a is the same as that of the ring part 30a of the rolling bearing holding part 30 described above, in descriptions thereof, components the same as those of the ring part 30a of the above-described rolling bearing holding part will be denoted with the same reference numerals and descriptions thereof will be omitted.

In this modified example, since the rolling bearing holding part 31 has only the ring part 30a, the structure of the rolling bearing holding part 31 is simplified and an increase in production costs can be reduced. In addition, the outer circumferential surface of the rolling bearing 25 can be brought into contact with the inner surface of the ring part 30a in the circumferential direction. Therefore, it is possible to further increase the holding rigidity of the rolling bearing 25.

In addition, for example, as shown in FIG. 5b, a rolling bearing holding part 32 includes the ring part 30a, the rim part 30b, and the top part 30d, and may have a bottomed cylindrical shape (Modified Example 2).

In this modified example, compared to the rolling bearing holding part 30 having the protrusion part 30c, since the protrusion part 30c is not provided, it is possible to simplify the structure. In addition, since the rolling bearing holding part 32 has the rim part 30b, if the rim part 30b is positioned with respect to a mold during insert molding, positioning of the rolling bearing holding part 32 in the axial direction with respect to the resin housing 13 can be easily performed. In addition, since the rolling bearing holding part 32 has the top part 30d, displacement of the shaft 11 to the rear side is prevented and it is possible to prevent a possibility of the rear side end of the shaft 11 coming in contact with the resin housing 13 and the resin housing 13 wearing.

In addition, for example, as shown in FIG. 5c, in a rolling bearing holding part 33, the rim part 30b may have a protrusion part that protrudes to the side in front of the ring part (Modified Example 3).

Compared to the rolling bearing holding part 30 (refer to FIG. 2) having the through-hole 30c1 at the protrusion part 30c, in this modified example, since there is no through-hole, it is possible to reduce the number of production steps and reduce an increase in cost. In addition, since the rim part 30b has the protrusion part 30c that protrudes to the side (+Z side) behind the ring part 30a, when the rolling bearing holding part 33 tries to rotate around the central axis according to rotation of the shaft 11 when the motor unit 10 is driven, if the protrusion part 30c is provided over the entire circumference of the rolling bearing holding part 33 in the circumferential direction, rotation of the rolling bearing holding part 33 can be prevented by a bonding force between the protrusion part 30c and the resin filled in during insert molding. In addition, when the protrusion part 30c is provided in a part of the rolling bearing holding part 33 in the circumferential direction, the protrusion part 30c hits the resin filled in during insert molding and rotation of the rolling bearing holding part 33 can be prevented. That is, when the rim part 30b includes the protrusion part 30c that protrudes to the side behind the ring part 30a, it is possible to prevent rotation of the rolling bearing holding part 33.

(Modified Example in Which Position of Front Side End 13d of Resin Housing 13 is Changed)

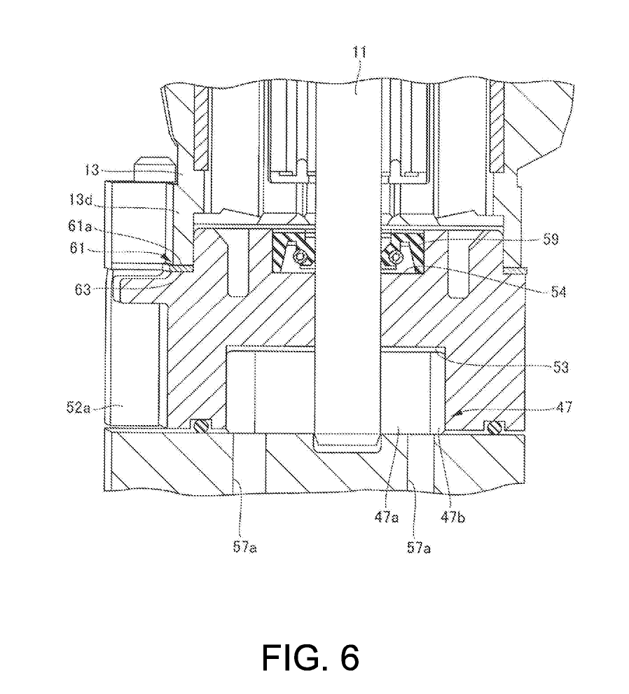

The front side end 13d of the resin housing 13 according to the first embodiment shown in FIG. 2 is disposed between the sealing member 59 and the housing part 53. However, the present disclosure is not limited to this structure. For example, as shown in FIG. 6, the front side end 13d of the resin housing 13 may be disposed at a position overlapping the sealing member 59 in the radial direction (Modified Example 4).

In this modified example, since the front side end 13d of the resin housing 13 is a position overlapping the sealing member 59 in the radial direction, there is no resin housing 13 on the side of the housing part 53 with respect to the sealing member 59. Here, in order to increase an amount of discharge by the pump unit 40 without increasing the size of the electric oil pump 1, there is a need to increase the size of the pump rotor 47 and change the size of the housing part 53 in which the pump rotor 47 is housed. In this case, since there is no resin housing 13 on the side of the housing part 53 with respect to the sealing member 59, it is possible to increase the degree of freedom in designing of the housing part 53.

(Modified Example in Which Distance Between Rear Side End of Shaft 11 and Top Part 30d of Rolling Bearing Holding Part 30 is Specified)

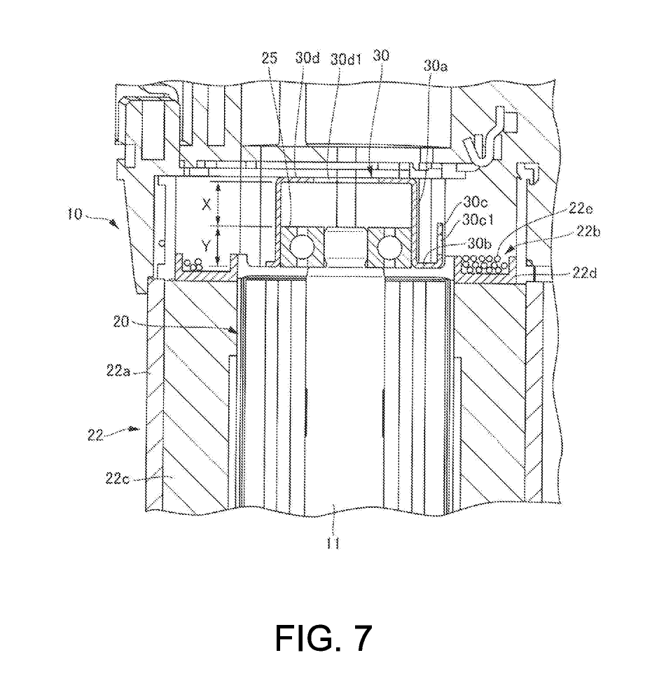

FIG. 7 is an enlarged cross-sectional view of the shaft 11 and the rolling bearing holding part 30 according to a modified example of the first embodiment. A relationship between a distance X between the rear side end of the shaft 11 according to the first embodiment shown in FIG. 2 and the inner surface of the top part 30d of the rolling bearing holding part 30 and the width Y of the rolling bearing 25 in the axial direction is not specified in detail. However, since the rolling bearing 25 has play in the axial direction, the shaft 11 may move in the axial direction. Here, as shown in FIG. 7, the distance X between the rear side end of the shaft 11 supported by the rolling bearing 25 and the inner surface of the top part 30d of the rolling bearing holding part 30 has a size that does not exceed the width Y of the rolling bearing 25 that supports the shaft 11 in the axial direction (Modified Example 5). That is, a gap having a size that does not exceed the width Y of the bearing 25 in the axial direction is provided between the rear side end of the shaft 11 and the inner surface of the top part 30d of the rolling bearing holding part 30.

While there is play in the rolling bearing 25 in the axial direction in this modified example, generally, the size of the play is smaller than the size of the width Y of the rolling bearing 25 in the axial direction. Therefore, the distance X between the rear side end of the shaft 11 supported by the rolling bearing 25 and the inner surface of the top part 30d of the rolling bearing holding part 30 has a size that does not exceed the width Y of the rolling bearing 25 that supports the shaft 11 in the axial direction. Therefore, even if the shaft 11 is shifted to the rear side according to the play of the rolling bearing 25, it is possible to prevent a possibility of the front side end of the shaft 11 coming in contact with the resin housing 13.

While exemplary embodiments of the present disclosure have been described above, the present disclosure is not limited to such embodiments, and various modifications and alternations within the spirit and scope of the present disclosure can be made. These embodiments and modifications thereof are included in the spirit and scope of the present disclosure and also in the scope of claims and equivalents thereof.

What is claimed is:

1. An electric oil pump comprising:
a motor unit having a shaft centered on a central axis that extends in an axial direction of the shaft; and
a pump unit which is disposed on one side of the motor unit in the axial direction, is driven by the motor unit via the shaft, and discharges oil,
wherein the motor unit comprises
a rotor that is fixed to an other side of the shaft in the axial direction;
a stator that is disposed outside the rotor in a radial direction; and
a resin housing in which the rotor and the stator are housed,
wherein the pump unit comprises
a pump rotor installed to the shaft that protrudes from the motor unit to the one side in the axial direction; and
a pump housing having a housing part in which the pump rotor is housed,
wherein the pump housing comprises
a pump body that is supported by the shaft via a sliding bearing; and
a pump cover that covers one side of the pump body in the axial direction,
wherein the other side of the shaft in the axial direction is supported by the resin housing via a rolling bearing, and
wherein one side of the shaft that protrudes from the motor unit in the axial direction is supported by the pump body via the sliding bearing.

2. The electric oil pump according to claim 1,
wherein the stator has a resin molded part.

3. The electric oil pump according to claim 1,
wherein the resin housing has a rolling bearing holding part that holds the rolling bearing, and
wherein the rolling bearing holding part is formed of a metal member.

4. The electric oil pump according to claim 3,
wherein the rolling bearing holding part has a ring part that surrounds and holds an outer circumference of the rolling bearing.

5. The electric oil pump according to claim 4,
wherein the rolling bearing holding part comprises the ring part, a rim part that extends from the ring part to outside in the radial direction and a top part that covers an opening on other side of the ring part in the axial direction, and has a bottomed cylindrical shape.

6. The electric oil pump according to claim 5,
wherein the rolling bearing holding part is integrated with the resin housing by insert molding.

7. The electric oil pump according to claim 6,
wherein the rim part has a protrusion part that protrudes to the other side of the ring part in the axial direction.

8. The electric oil pump according to claim 7,
wherein the protrusion part has a through-hole that penetrates through the protrusion part.

9. The electric oil pump according to claim 1,
wherein a step that is recessed inwardly in the radial direction is provided on an outer surface outside the pump body in the radial direction, and
wherein one side end of the resin housing in the axial direction is fixed to the step.

10. The electric oil pump according to claim 1,
wherein the pump body has a recess that is recessed from a surface at the other side in the axial direction to the one side in the axial direction,
wherein the sliding bearing is a through-hole that allows communication between the recess and the housing part, and
wherein a sealing member is provided in the recess.

11. The electric oil pump according to claim 10,
wherein one side end of the resin housing in the axial direction is disposed at a position overlapping the sealing member in the radial direction.

12. The electric oil pump according to claim 10,
wherein one side end of the resin housing in the axial direction is disposed between the sealing member and the housing part.

13. The electric oil pump according to claim 5,
wherein a distance between an other side end of the shaft supported by the rolling bearing in the axial direction and an inner surface of the top part of the rolling bearing holding part is larger than a width of the rolling bearing that supports the shaft in the axial direction.
